(19) United States
(12) Patent Application Publication
(10) Pub. No.: US 2020/0364672 A1
(43) Pub. Date: Nov. 19, 2020

(54) SYSTEM AND METHOD FOR MEASURING AND MONITORING ENGAGEMENT

(71) Applicant: Blackhawk Network, Inc., Pleasanton, CA (US)

(72) Inventors: Egan Cheung, Toronto (CA); Aris Zakinthinos, Toronto (CA); Natalie Monarch Baumgartner, Boulder, CO (US); Sarah Ann Lindsay, Toronto (CA)

(21) Appl. No.: 16/766,351

(22) PCT Filed: Nov. 30, 2018
(86) PCT No.: PCT/US2018/063414

§ 371 Date: May 22, 2020

Related U.S. Application Data
(60) Provisional application No. 62/592,739, filed on Nov. 30, 2017.

(51) Int. Cl. G06Q 10/10; G06Q 30/02; G06Q 10/06

(52) U.S. Cl. CPC G06Q 10/1053; G06Q 10/063; G06Q 30/0203

(57) ABSTRACT

A computer-implemented method for evaluating personnel engagement. The method may include distributing engagement surveys to a plurality of persons associated with an organization, analyzing the engagement surveys in real-time to obtain one or more engagement survey results, and reporting the engagement survey results in real-time. Also, a system for evaluating personnel engagement. The system may comprise a personnel assessment computer. The personnel assessment computer configured to distribute engagement surveys to a plurality of persons associated with an organization, analyze the engagement surveys in real-time to obtain one or more engagement survey results, and report the engagement survey results in real-time.

### CROSS-REFERENCE TO RELATED APPLICATIONS

This application is a filing under 35 U.S.C. 371 of International Application No. PCT/US2018/063414 filed Nov. 30, 2018, which is a continuation of and claims priority to provisional application U.S. Ser. No. 62/592,739 filed Nov. 30, 2017 by Egan Cheung, et al., and entitled “System and Method for Measuring and Monitoring Engagement,” which is incorporated herein by reference in its entirety.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The disclosure generally relates to evaluating, for example, measuring and monitoring, engagement by personnel, such as employees, associated with an organization, such as an employer.

### BACKGROUND

Even though most organizations may attempt to measure engagement of their personnel, the systems and methodology employed to gauge personnel engagement have not effectively moved in recent years. Moreover, many estimate that engagement by personnel has diminished considerably in recent years. For example, about a decade ago, estimates were that one out of every three employees were considered, by the employer, to be “engaged.” More recent estimates, however, indicate that personnel engagement has fallen to only one out of every four employees. This decrease in in personnel engagement comes at a significant cost.

More particularly, employers often fear that that key personnel may leave the company with little or no warning. While employers or management within an organization may perceive that the organization is a desirable place to work, employees may feel otherwise. For example, employers or managers may perceive organizational culture differently from other personnel, may perceive compensation and incentives differently from other personnel, may perceive the availability of resources differently from other personnel, or may perceive recognition schemes differently from other personnel. Often, the disconnect between employers and personnel could have been easily remedied, had employers only recognized the need to do so.

The cost of this turnover in personnel is often significant. Not only are there costs associated with hiring a replacement and losses in productivity, but there are often further losses in efficiency and the time necessary for a replacement hire to become efficient. Some employers have estimated that for every employee turn-over event, the organization loses about a year of productivity.

As such, what is needed are improved methods and systems of addressing personnel engagement.

### SUMMARY

In some embodiments disclosed herein is a computer-implemented method of evaluating personnel engagement comprising distributing engagement surveys to a plurality of persons associated with an organization, analyzing the engagement surveys in real-time to obtain one or more engagement survey results, and reporting the engagement survey results in real-time. Additionally or alternatively, in some embodiments, the engagement surveys may each comprise from about 10 to about 20 questions related to engagement. Additionally or alternatively, in some embodiments the engagement surveys are distributed at least bi-annually. Additionally or alternatively, in some embodiments analyzing the engagement survey comprises determining a group or organizational value. Additionally or alternatively, in some embodiments analyzing the engagement survey comprises determining a group or organization cultural archetype based on the group or organizational value. Additionally or alternatively, in some embodiments analyzing the engagement survey comprises determining an intra-group conflict value. Additionally or alternatively, in some embodiments analyzing the engagement survey comprises determining an inter-group conflict value. Additionally or alternatively, in some embodiments analyzing the engagement survey comprises determining a culture fit score. For example, the culture fit score may be for a person with respect to another person, for a person with respect to a group and/or for a group with respect to another group. Additionally or alternatively, in some embodiments at least one of the persons is a prospective employee.

Also disclosed herein is a system for evaluating personnel engagement, the system comprising a personnel assessment computer configured to distribute engagement surveys to a plurality of persons associated with an organization, analyze the engagement surveys in real-time to obtain one or more engagement survey results, and report the engagement survey results in real-time. Additionally or alternatively, in some embodiments the engagement surveys each comprise from about 10 to about 20 questions related to engagement. Additionally or alternatively, in some embodiments the personnel engagement computer is configured to distribute the engagement surveys at least bi-annually. Additionally or alternatively, in some embodiments the personnel engagement computer is configured to analyze the engagement survey by determining a group or organizational value. Additionally or alternatively, in some embodiments the personnel engagement computer is configured to analyze the engagement survey by determining a group or organization cultural archetype based on the group or organizational value. Additionally or alternatively, in some embodiments the personnel engagement computer is configured to analyze the engagement survey by determining an intra-group conflict value. Additionally or alternatively, in some embodiments the personnel engagement computer is configured to analyze the engagement survey by determining an inter-group conflict value. Additionally or alternatively, in some embodiments the personnel engagement computer is configured to analyze the engagement survey by determining a culture fit score. For example, the culture fit score may be for a person with respect to another person, for a person with respect to a group, and/or for a group with respect to another group. Additionally or alternatively, in some embodiments at least one of the persons is a prospective employee.

### BRIEF DESCRIPTION OF THE DRAWINGS

FIG. 1 is a schematic illustration of an embodiment of a system for evaluating personnel engagement.

FIG. 2 is an embodiment of the personnel-engagement computer.

FIG. 3 is an embodiment of a method of evaluating personnel engagement.

FIG. 4 is an embodiment of an engagement survey report.

FIG. 5 is an embodiment of a method of evaluating personnel engagement.

FIG. 6 is an embodiment of a method of evaluating personnel engagement.

FIG. 7 is an embodiment of a method of evaluating personnel engagement.

FIG. 8 is an embodiment of a method of evaluating personnel engagement.

### DETAILED DESCRIPTION

Disclosed herein are methods and systems for evaluating personnel engagement. In various embodiments, the personnel that are the subject of the methods and systems disclosed herein may be, with respect to a particular organization, any employee, whether salaried, temporary, or hourly; staff; agent; contractor; affiliate; or other person otherwise engaged with the organization. Also, in various embodiments, the personnel may be members of a particular work-group, sub-group, department, or location within an organization or within the organization in its entirety. Additionally, in various embodiments, the methods and systems for evaluating personnel engagement may be applied with respect to current personnel, prospective personnel, or both.

In various embodiments, “engagement” of personnel may refer to some person's level of commitment to, attention to, interest in, and/or intentness with respect to the organization of which they are a part. For example, personnel exhibiting relatively high levels of engagement may tend to be characterized as absorbed in and enthusiastic about their work and/or as having a positive view of the organization. Conversely, personnel exhibiting relative levels of engagement may tend to be characterized as disconnected from and indifferent about their work and as not be particularly interested in the organization. Generally, organizations tend to prefer that their personnel be engaged, not only because engaged employees are believed to be more productive than relatively less engaged personnel, but also in that engaged employees are also exhibit a longer tenure with the organization.

In various embodiments, the methods and systems disclosed herein may be employed to provide a quantification of various aspects of personnel engagement. More particularly, in various embodiments, the methods and systems disclosed herein may utilize novel algorithms to evaluate personnel assessments. Also, in some embodiments, based upon those evaluations, the methods and systems disclosed herein may also predict whether or not a particular person will suitable member of a particular organization or group. Additionally or alternatively, in some embodiments, based upon those evaluations, the methods and systems disclosed herein may predict potential measures to shift the culture of an organization or group. Additionally or alternatively, in some embodiments, based upon one or more of those evaluations, the methods and systems disclosed herein may predict potential measures to improve engagement by one or more particular persons.

For example, in some embodiments the methods and systems may be related to gathering and reporting, in real-time, engagement data. Additionally or alternatively, in some embodiments the methods and systems may be related to defining an organization's culture. Additionally or alternatively, in some embodiments the methods and systems may be related to performance of a gap-analysis between an organizations desired culture and the organization's current culture. Additionally or alternatively, in some embodiments may be related to determination of potential conflicts between members of a particular group and/or potential conflicts between two or more groups.

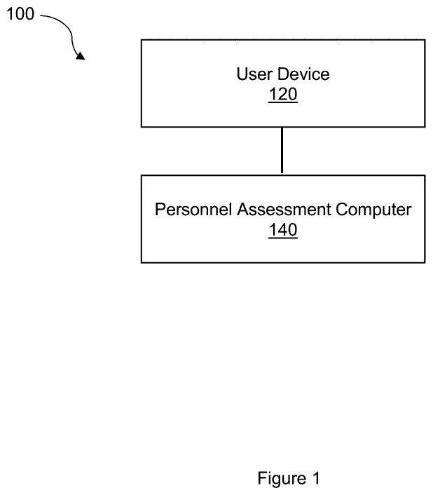

In some embodiments, the method disclosed herein may be implemented via a personnel engagement system 100. For example, referring to FIG. 1 is a schematic illustration of an embodiment of the personnel engagement system 100. In the embodiment of FIG. 1, the system 100 generally includes a user device 120 and a personnel assessment computer 140.

In various embodiments, the components of the system 100 may be operably connected via one or more networks (for example, a broadband network, an optical network, a Wi-Fi network, a Bluetooth network, a near-field communication (NFC) network, a cellular network, a satellite network, a cloud network, a card processing network, a banking network, a local area network, the World Wide Web for Internet, a non-cellular mobile phone network, a land-line network, a Public Switched Telephone Network (PSTN), a dedicated communication line, some other networks for transferring electronic information, or combinations thereof). Particularly, in some embodiments, the personnel assessment computer 140 may be operably connected to, for example, in signal communication with the user device 120.

In various embodiments, the user device 120 may comprise a personal computer, a tablet, a mobile phone such as a smartphone, a cloud computing system, a server, or combinations thereof. The user device 120 may be configured by the user or consumer to send, receive, and/or access one or more electronic messages having a suitable format. For example, in various embodiments, the electronic message may be formatted as electronic mail (i.e., an email such as email utilizing simple mail transfer protocol (SMTP) or another suitable protocol); a short-message-service (SMS) (i.e., a “text” message); an instant message (IM); a personal message or private message (PM), for example, which may be provided via a social-networking platform (e.g., Twitter, Facebook, Instagram) or via a private messaging platform (e.g., WhatsApp, Kik Messenger, Snapchat); or combinations thereof.

Additionally or alternatively, in some embodiments the user device 120 may also be configured to provide Internet access, for example, comprising suitable hardware and software (e.g., an Internet browser) for connection to and navigation of various networks via which Internet access may be obtained. Additionally or alternatively, in some embodiments the user device 120 may be configured to provide access to an organizational intranet. The user device 120 may also comprise a suitable user interface, for example, a graphical user interface which may be implemented and/or manipulated via a touch screen, a keyboard, a mouse, a trackball, voice-command, or combinations thereof.

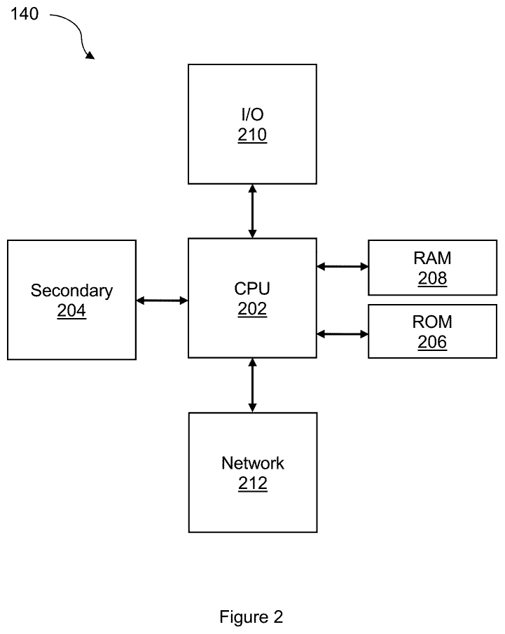

In various embodiments, personnel assessment computer 140 may be generally configured to perform one or more steps of the methods generally disclosed herein. The personnel assessment computer 140 comprises and is implemented via a particular machine generally comprising sufficient processing power, memory resources, and network throughput capability to handle the necessary workload placed upon it. FIG. 2 illustrates an embodiment of the personnel assessment computer 140 suitably configured to implement all, or a portion of, one or more embodiments disclosed herein. The personnel assessment computer 140 includes a processor 202 (which may be referred to as a central processor unit or CPU) that is in communication with memory devices including secondary storage 204, read only memory (ROM) 206, random access memory (RAM) 208, input/output (I/O) devices 210, and network connectivity devices 212. The processor 202 may be implemented as one or more CPU chips.

It is understood that by programming and/or loading executable instructions onto the personnel assessment computer 140, at least one of the CPU 202, the RAM 208, and the ROM 206 are changed, transforming the personnel assessment computer 140 in part into a particular machine (and/or a special-purpose computer) having the particular, novel functionalities disclosed herein and thereby enabled to perform the novel and nonobvious methods, tasks, processes, and steps disclosed herein; thus, the personnel assessment computer 140 does not constitute and cannot be implemented via a general purpose machine. It is fundamental to the electrical engineering and software engineering arts that a particular functionality that can be implemented by loading executable software into a computer (or a component thereof) and, likewise, that a particular functionality that can be implemented via hardware utilizing well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer that has been programmed and/or loaded with executable instructions may be viewed as a particular machine (and/or special-purpose computer).

In some embodiments, the secondary storage 204 may be comprised of one or more disk drives or tape drives, for example, which may be used for non-volatile storage of data and as an over-flow data storage device if RAM 208 is not large enough to hold all working data. Secondary storage 204 may be used to store programs which are loaded into RAM 208 when such programs are selected for execution. The ROM 206 is used to store instructions and perhaps data which are read during program execution. ROM 206 is a non-volatile memory device which typically has a small memory capacity relative to the larger memory capacity of secondary storage 204. The RAM 208 is used to store volatile data and perhaps to store instructions. Access to both ROM 206 and RAM 208 is typically faster than to secondary storage 204. The secondary storage 204, the RAM 208, and/or the ROM 206 may be referred to in some contexts as computer readable storage media and/or non-transitory computer readable media.

In some embodiments, the I/O devices 210 may include printers, video monitors, liquid crystal displays (LCDs), touch screen displays, keyboards, keypads, switches, dials, mice, track balls, voice recognizers, card readers, paper tape readers, or other well-known input devices.

In some embodiments, the network connectivity devices 212 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. These network connectivity devices 212 may enable the processor 202 to communicate with the Internet or one or more intranets. With such a network connection, it is contemplated that the processor 202 might receive information from the network or might output information to the network in the course of performing the herein-described method steps. Such information, which is often represented as a sequence of instructions to be executed using processor 202, may be received from and outputted to the network, for example, in the form of a computer data signal embodied in a carrier wave.

Such information, which may include data or instructions to be executed via the processor 202 may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 202 executes instructions, codes, computer programs, scripts which it accesses from a hard disk, a floppy disk, an optical disk (these various disk-based systems may all be considered secondary storage 204), ROM 206, RAM 208, or the network connectivity devices 212. While only one processor 202 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 204, for example, hard drives, floppy disks, optical disks, and/or other device, the ROM 206, and/or the RAM 208 may be referred to in some contexts as non-transitory instructions and/or non-transitory information.

In some embodiments, the personnel assessment computer 140 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the personnel assessment computer 140 to provide the functionality of a number of servers that is not directly bound to the number of computers in the personnel assessment computer 140. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third-party provider. Some cloud computing environments may comprise cloud computing resources owned and operated by the enterprise as well as cloud computing resources hired and/or leased from a third-party provider.

In some embodiments, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer-usable program code. The computer program product may be embodied in removable computer storage media and/or non-removable computer storage media. The removable computer readable storage medium may comprise, without limitation, a paper tape, a magnetic tape, magnetic disk, an optical disk, a solid-state memory chip, for example analog magnetic tape, compact disk read only memory (CD-ROM) disks, floppy disks, jump drives, digital cards, multimedia cards, and others. The computer program product may be suitable for loading, by the personnel assessment computer 140, at least portions of the contents of the computer program product to the secondary storage 204, to the ROM 206, to the RAM 208, and/or to other non-volatile memory and volatile memory of the personnel assessment computer 140. The processor 202 may process the executable instructions and/or data structures in part by directly accessing the computer program product, for example by reading from a CD-ROM disk inserted into a disk drive peripheral of the personnel assessment computer 140. Alternatively, the processor 202 may process the executable instructions and/or data structures by remotely accessing the computer program product, for example by downloading the executable instructions and/or data structures from a remote server through the network connectivity devices 212. The computer program product may comprise instructions that promote the loading and/or copying of data, data structures, files, and/or executable instructions to the secondary storage 204, to the ROM 206, to the RAM 208, and/or to other non-volatile memory and volatile memory of the personnel assessment computer 140.

In some contexts, the secondary storage 204, the ROM 206, and the RAM 208 may be referred to as a non-transitory computer readable medium or a computer readable storage media. A dynamic RAM embodiment of the RAM 208, likewise, may be referred to as a non-transitory computer readable medium in that while the dynamic RAM receives electrical power and is operated in accordance with its design, for example during a period of time during which the personnel assessment computer 140 is turned on and operational, the dynamic RAM stores information that is written to it. Similarly, the processor 202 may comprise an internal RAM, an internal ROM, a cache memory, and/or other internal non-transitory storage blocks, sections, or components that may be referred to in some contexts as non-transitory computer readable media or computer readable storage media.

In various embodiments, the personnel assessment computer 140 may be configured to perform all, substantially all, or part of one or more of the methods disclosed herein, for example, a method of providing a quantification of various aspects of personnel engagement, a method of evaluating personnel assessments, a method of predicting whether or not a particular person will suitable member of a particular organization or group, a method predicting potential measures to shift the culture of an organization or group, a method of predicting potential measures to improve engagement by one or more particular persons, or combinations thereof. In some embodiments, the personnel assessment computer 140 may be configured to perform one or more of the steps of the methods disclosed herein in real-time or substantially in real-time. As used herein, processing in “real-time” refers broadly to completion of one or more processing tasks, from receipt of an input to generation of an output based upon that input, without any appreciable delay, for example, as opposed to “batch” processing.

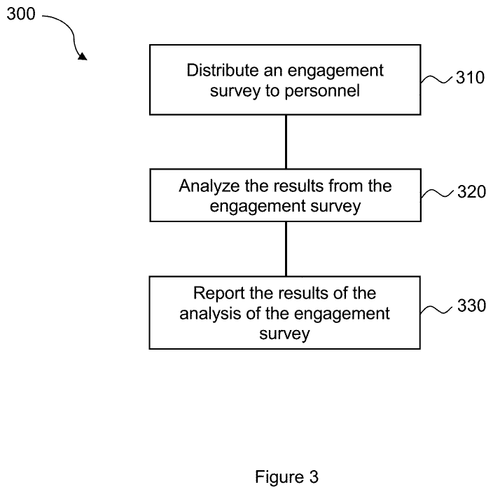

For example, referring to FIG. 3, an embodiment of a method 300 of evaluating personnel engagement is illustrated. In the embodiment of FIG. 3, the method 300 comprises distributing an engagement survey to personnel (at block 310). For example, the personnel assessment computer 140 may cause an engagement survey to be distributed electronically via the user device 120. For example, in various embodiments, the personnel assessment computer 140 may cause the engagement survey may be distributed to various personnel via an email, a text message, an instant message, a personal message or private message (PM) via a social-networking platform or via a private messaging platform. Additionally or alternatively, in some embodiments, the personnel assessment computer 140 may cause the engagement survey to be presented to personnel upon logging into, via the user device 120, an organizational intranet, for example.

In various embodiments, the engagement survey may comprise a plurality of questions, for example, from about 1 question to about 25 questions, or from about 5 questions to about 20 questions, or from about 10 questions to about 20 questions. For example, the engagement survey may include about 10, 11, 12, 13, 14, 15, 16, 17, 18, 19, or 20 questions. In some embodiments, the questions set forth in the engagement survey may be directed, collectively, to the six (6) drivers of personnel engagement, for example, perception of job importance, clarity of job expectations, career advancement opportunities, feedback from superiors, quality of working relationships, perceptions of the organizational values and culture, and internal employee communications. For example, each survey may include from about two (2) to about four (4) questions directed to each of these drivers of personnel engagement.

In various embodiments, the personnel assessment computer 140 may cause the engagement surveys to be distributed at regular intervals and/or on-demand. For example, the engagement surveys may be distributed weekly, bi-weekly, monthly, bi-monthly, quarterly, biannually, or annually. In some embodiments, the engagement survey distributed on one occasion may be the same as or substantially the same as the engagement survey distributed on another occasion. Alternatively, in some embodiments, the engagement survey distributed on one occasion may differ with respect to the engagement survey distributed on another occasion. For example, the questions included within the engagement survey may be changed over time. In some embodiments, the questions included within an engagement survey may be based upon the questions included in a previous engagement survey and/or the responses to those questions. Additionally or alternatively, in some embodiments the engagement survey need not be distributed in its entirety at a single time. For example, the questions of an engagement may be presented over a period of time, such as a few questions over the course of several days.

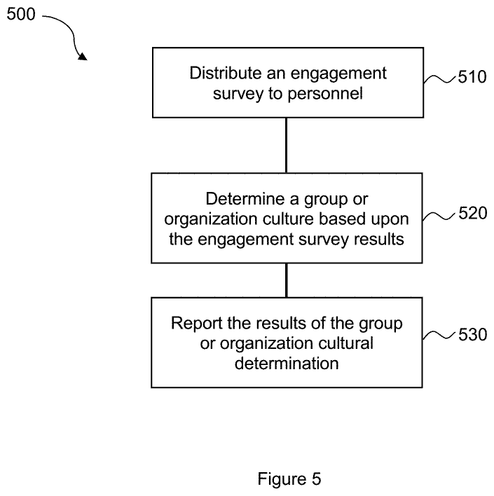

In the embodiment of FIG. 3, the method 300 also comprises analyzing the results from the engagement survey (at block 320). For example, in various embodiments as will be disclosed herein, various algorithms and scoring protocols may be employed to analyze the results of the engagement surveys. In various embodiments, and dependent upon the intended result of the analysis, the algorithms and scoring protocols may be utilized to compare a particular person's engagement survey results to the engagement survey results of a group (or the organization in its entirety), to compare a particular person's engagement survey results to the results of a previous engagement survey by that person, to compare a particular person's engagement survey results to an ideal result or a benchmark, compare a particular person's engagement survey results to industry norms or expectations, to compare a particular group's engagement survey results to another group's engagement survey results (or the organization in its entirety), to compare a particular group's engagement survey results to the results of a previous engagement survey by that group, to compare a particular group's engagement survey results to an ideal result or a benchmark, to compare a particular group's engagement survey results to industry norms or expectations, or combinations thereof. Specific examples of algorithms and scoring protocols are disclosed herein, for example, with respect to FIGS. 5, 6, 7, and 8, although suitable alternatively algorithms and scoring protocols will be appreciated by one of skill in the art upon viewing this disclosure.

In the embodiment of FIG. 3, the method 300 also comprises reporting the results of the analysis of the engagement survey (at block 330). For example, in some embodiments, the results of the analysis of the engagement survey may be made available to a group leader, a manager, or other interested persons via a dashboard. Additionally or alternatively, in some embodiments, the results of the analysis of the engagement survey may be sent to a group leader, manager, or other interested person via an electronic message.

In various embodiments, an engagement survey report may comprise various data derived from the analysis of the engagement survey results, for example, indications of the engagement of particular persons or particular groups, indications of how the engagement of particular persons or groups compares to other persons or groups, indications of how the engagement of particular persons or groups has changed over time, or the like. Additionally or alternatively, in some embodiments the engagement survey report may comprise data from the results of the engagement survey, for example, responses to particular questions, comments made by personnel, or the like. Additionally or alternatively, in some embodiments the engagement survey report may comprise one or more recommendations based on the engagement survey results. For example, in some embodiments the personnel assessment computer 140 may, based upon the results of the personnel engagement surveys, make recommendations as to actions that can be taken to improve personnel engagement with respect to one or more individuals or with respect to various groups. For example, the personnel engagement report may suggest actions, such as in-person commendations, group or team recognition, or the like. The suggested actions may be based upon the analysis of engagement survey results, such as by taking into account the values of personnel or groups and using these values to identify actions most-likely to have a positive result.

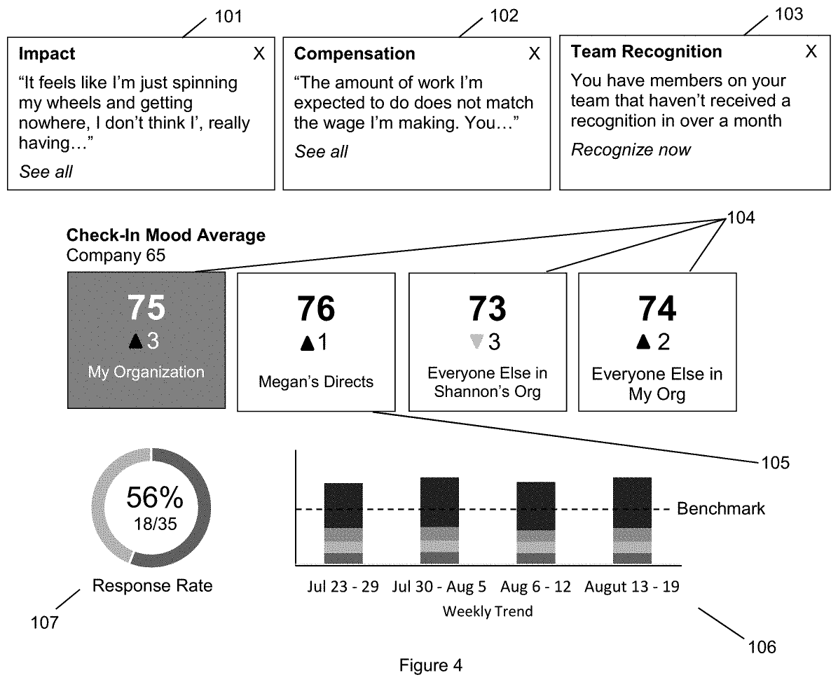

As an example, and referring to FIG. 4, an embodiment of an engagement survey report 400 is shown. In the embodiment of FIG. 4, the engagement survey report 400 includes comments made by personnel concerning impact 101, comments made by personnel concerning compensation 102, and comments made by personnel concerning team recognition 103. Also in the embodiment of FIG. 4, the engagement survey report 400 includes a quantitative indication of the “mood” of a group of employees 104, a quantitative indication of the “mood” of a single employee, and indications of mood trends, historically 106.

Additionally or alternatively, referring to FIG. 5, a method 500 of evaluating personnel engagement is illustrated. In the embodiment of FIG. 5, the method 500 may be particularly well-suited to the determination of group or organizational values. In the embodiment of FIG. 5, the method 500 comprises distributing an engagement survey to personnel (at block 510), as similarly disclosed with respect to FIG. 3. In the embodiment of FIG. 5, the surveys may include one or more questions related to group or organizational values. For example, personnel may be asked to identify value statements that are most-important to them and to identify value statements that are least-important to them.

In the embodiment of FIG. 5, the method 500 also comprises determining a group or organization culture based upon the engagement survey results (at block 520). For example, the selected values may be summed for all survey responses using one positive vote for any value that a respondent finds most-important and one negative vote for any value that a respondent finds least-important, for example, as shown.

$$PC = {\sum }_{members}^{1} Top 9 Values$$

$$NC = {\sum }_{members}^{1} Bottom 9 Values$$

The ranked importance of the values for the group or organization may be determined by ordering the rolled up value set, for example, as shown.

$$ln ( \frac{PC + 1.0}{NC + 1.0} ) * {( \frac{total selections}{group size} )}^{2}$$

The highest scoring nine (9) values in the sorted set are used as the most-important values (the “Top 9”) for the group or organization and the lowest scoring nine (9) values in the sorted set are used as the least-important values (the “Bottom 9”) for the group or organization. While the method disclosed herein used the Top 9 and Bottom 9 values, in other embodiments, any suitable number of values may likewise be used in the analysis.

In additional or alternative embodiments, the values of a group or organization may be determined utilizing various suitable datasets. For example, in some embodiments, instead of using all members of the group or organization, the members are limited to only top performers within the group or organization, for example, such as the top 10% of performers. In some embodiments, instead of using all members of the group of organization, the members are limited to only those who have been a part of the group or organization for a certain number of years, for example, at least 1 year, 2 years, 3, years, 4 years, 5 years, etc. In some embodiments in instead of using all members of the group of organization, the members are limited to only those who exemplify the group or organizational culture. In some embodiments, a weight may be attached to a particular member's value selections. For example, in a hierarchy, weight may be attached to a member's value selections based upon the number of other members that report, directly or indirectly, to that member, as shown.

$$weighting factor = 1.0 + ( \frac{\# of reporting members}{size of group} )$$

Also for example, a weight may be attached to a particular member's value selections based upon that member's contributions to the group or organization, as shown.

$$weighting factor = 1.0 + ( \frac{rank of group}{size of group} )$$

In some embodiments, a group or organizational culture can be determined from the value rankings, for example, the Top 9 values and the Bottom 9 values. For example, predefined culture archetypes may have certain most-important values and least-important values associated therewith. For example, based upon previously completed cultural assessments, the distribution of values with respect to culture archetype can be determined. This calculation is defined as the count of the intersection set of the user selected value set and the archetype value set. Utilizing a vector of size 18 (e.g., where a Top 9 and Bottom 9 values are used), the number of persons that match for 1 value for each archetype are summed, likewise, the number of persons that match for 2 values, 3 value, 4 values, etc., are all summed. This forms the basis for an empirical distribution function. Using this function, a member's score for each cultural archetype can be calculated as a percentile with respect to the empirical distribution function. Taken together for the group or organizational members, these scores yield the cultural archetype.

In the embodiment of FIG. 5, the method 500 comprises reporting the results of the group or organizational cultural determination (at block 530), as also similarly disclosed with respect to FIG. 3.

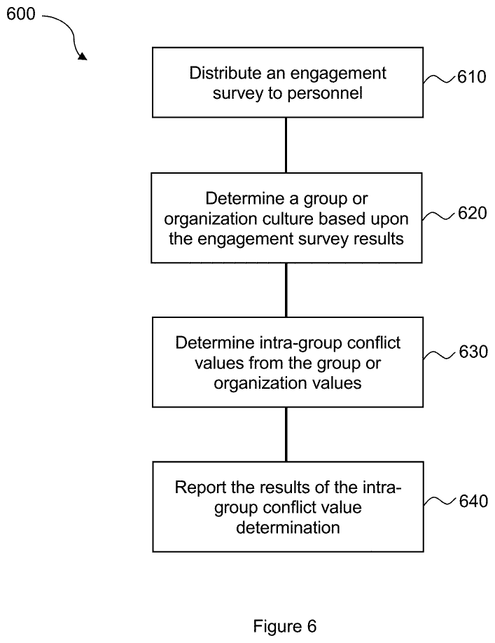

Additionally or alternatively, referring to FIG. 6, another embodiment of a method 600 of evaluating personnel engagement is illustrated. In the embodiment of FIG. 6, the method 600 may be particularly well-suited to predicting intra-group conflict values. For example, and not intending to be bound by theory, intra-group conflict values may identify areas of potential conflict within a group, for example, based on highly-contested values, such as where some group members identify certain values as being most-important and other group members identify those same values as being least-important. Not intending to be bound by theory, where a significant number of total members select a particular value as being most-important and a significant number of total members select a particular value as being least-important, confusion and disagreement often result, particularly with respect to areas affected by that value, causing groups or organizations to operate sub-optimally.

In the embodiment of FIG. 6, the method 600 comprises distributing an engagement survey to personnel (at block 610), as similarly disclosed with respect to FIG. 3. Also, and as disclosed with respect to the embodiment of FIG. 5, the surveys may include one or more questions related to group or organizational values, such as identification of value statements that are most-important to them and value statements that are least-important to them. Also in the embodiment of FIG. 6, the method 600 comprises determining a group or organization culture based upon the engagement survey results (at block 620), as similarly disclosed with respect to FIG. 5.

In the embodiment of FIG. 6, the method 600 comprises determining intra-group conflict values from the group or organization values (at block 630). In some embodiments, determining the intra-group conflict values from the group or organization values may comprise determining an agreement ratio and a disagreement ratio. Generally, the agreement ratio may quantitatively define the strength of agreement with respect to a particular value by the overall bias or agreed upon voting direction in the group, for example, as shown.

$$Agreement Ratio = {Value}_{Agreement} = ( \frac{\begin{matrix}{Value}_{Positive Count} - \\ {Value}_{Negative Count}\end{matrix}}{{Value}_{TotalCount}} )$$

Also, generally, the disagreement ratio is the complement, for example, as shown.

Disagreement Ratio=1.0—Agreement Ratio

In some embodiments, determining the intra-group conflict values from the group or organization values may comprise determining a weighted disagreement ratio. For example, a weighted disagreement ratio may enable sorting the values most-in-conflict with respect to a group or organization, such as by blending the popularity of the value's selection by the group and the degree of disagreement among the members selecting the particular value. For example, the weight may be equal to the ratio of the value's selection to the size of the group, for example, as shown.

$$Weight = \frac{{Value}_{Count}}{{Group}_{Size}}$$

In some embodiments, the weighted disagreement is determined by multiplying the weight by the disagreement ratio.

Weighted Disagreement Ratio=(Weight)(Disagreement Ratio)

Additionally or alternatively, in some embodiments the weighted disagreement is determined by multiplying the square of the weight by the disagreement ratio, so as to increase the effect of the weight.

Weighted Disagreement Ratio=(Weight)²(Disagreement Ratio)

Upon determining the weighted disagreement ratio, the values may be sorted according to the respective ratios. In some embodiments, those value having a disagreement ratio exceeding a threshold value (e.g., 0.20) may be identified as conflicted values.

In some embodiments, certain values may have higher importance and/or greater effect as a conflict value that others and, as such, may be weighted differently. For instance, a value like “Doesn't list to be constrained by rules” may have more importance or effect as a conflict value than “Making friends at work.” In some embodiments, various values may be assigned their own weighting value in order to obtain those conflict values that are most-important or may have the greatest effect.

In the embodiment of FIG. 6, the method 600 comprises reporting the results of the intra-group conflict value determination (at block 640), as also similarly disclosed with respect to FIG. 3.

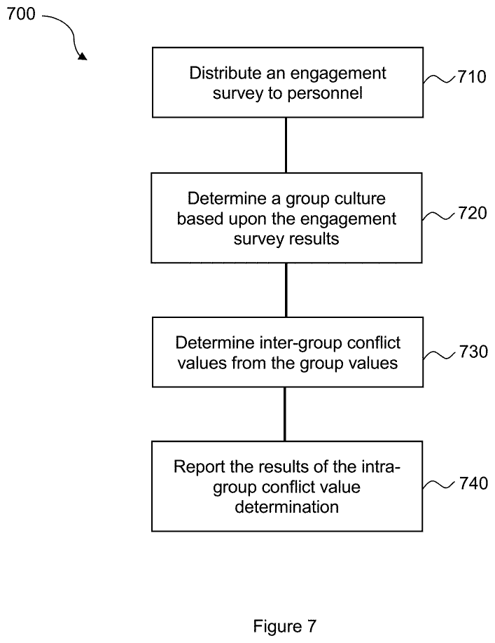

Additionally or alternatively, referring to FIG. 7, another embodiment of a method 700 of evaluating personnel engagement is illustrated. In the embodiment of FIG. 7, the method 700 may be particularly well-suited to predicting inter-group conflict values.

In the embodiment of FIG. 7, the method 700 comprises distributing an engagement survey to personnel (at block 710), as similarly disclosed with respect to FIG. 3. Also, and as disclosed with respect to the embodiment of FIG. 5, the surveys may include one or more questions related to group or organizational values, such as identification of value statements that are most-important to them and value statements that are least-important to them. Also in the embodiment of FIG. 7, the method 700 comprises determining a group culture based upon the engagement survey results, for each of two or more groups (at block 720), as similarly disclosed with respect to FIG. 5.

In the embodiment of FIG. 7, the method 700 comprises determining inter-group conflict values from the group values (at block 730). In some embodiments, determining the inter-group conflict values from the group or organization values may comprise determining a difference (e.g., a delta) between the normalized quantifications of a particular value for each of the groups. For example, in some embodiments, the quantification of a particular value may be normal by calculating a logarithm for the respective value. In some embodiments, the difference (e.g., a delta) between the normalized quantifications of a particular value for a first group and a second group can be determined, for example, as shown.

Δ=|log(Value_{Group1})-log (Value_{Group2})|

Additionally, in some embodiments, one or more of the values may be weighted, as similarly disclosed with respect to FIG. 6. For example, in some embodiments the values may be weighted so as to emphasize how often a particular value was selected by a group.

In the embodiment of FIG. 7, the method 700 comprises reporting the results of the inter-group conflict value determination (at block 740), as also similarly disclosed with respect to FIG. 3.

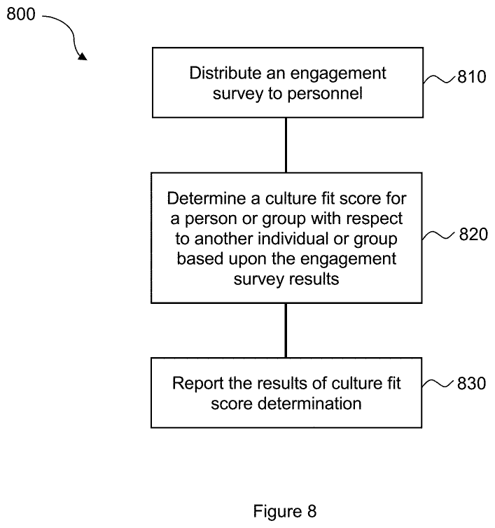

Additionally or alternatively, referring to FIG. 8, another embodiment of a method 800 of evaluating personnel engagement is illustrated. In the embodiment of FIG. 8, the method may be particularly well-suited to predicting whether or not a particular person will suitable member of a particular organization or group. For example, members of a group or organization and candidates for that group or organization may be compared to one another or against a desired culture value set. As disclosed herein, a group or organization may have a quantifiable set of values. For example, each value can have a weight based upon the number of times it is selected positively or selected negatively by members of the group or organization. Additionally or alternatively, a group or organization may select values that toward which or away from which they wish to direct the group or organization. If a value is selected toward which a bias is desired, that value may be weighted relatively more, such as by a percentage. The percentage may be se based upon the desired sensitivity, for example, so as to produces a particular desired culture.

In the embodiment of FIG. 8, the method 800 comprises distributing an engagement survey to personnel (at block 810), as similarly disclosed with respect to FIG. 3.

In the embodiment of FIG. 8, the method 800 comprises determining a culture fit score for a person or group with respect to another individual or group based upon the engagement survey results (at block 820). In some embodiments, it may be desirable to determine a culture fit score for a first person with respect to a second person, for example, to determine how well these two people might work together or as a part of a common team. In some embodiments, a culture fit score for a first person with respect to a second person may comprise scoring, across each of a plurality of culture values, by adding one (1) point where the first and second person match a particular value (e.g., both select as most-important or both select as least important), subtracting one (1) point where the first and second person conflict with respect to a particular value, and doing nothing (e.g., adding 0 points) for all other values. This will yield a raw score. In some embodiments, based on the raw score distribution of the entire population (e.g., all individuals evaluated), a percentile fit may be determined based upon place of the raw score within the empirical distribution function, as disclosed with respect to FIG. 5.

Additionally or alternatively, in some embodiments, it may be desirable to determine a culture fit score for a person with respect to a group, for example, to determine how well that person might work as a part of that group. In some embodiments, a culture fit score for the person with respect to the group may be determined by comparing the, across each of a plurality of culture values, the values of the person to the values of each group member by adding one (1) point where the person and a particular group member match a particular value (e.g., both select as most-important or both select as least important), subtracting one (1) point where the person and the particular group member conflict with respect to a particular value, and doing nothing (e.g., adding 0 points) for all other values. This will yield a value vector, V_{Val}. A group value vector, V_{Group}, may be calculated as previously discussed with respect to FIG. 5, particularly, as shown.

$$ln ( \frac{PC + 1.0}{NC + 1.0} ) * {( \frac{total selections}{group size} )}^{2}$$

The individual-to-group score can be calculated, for example, as shown, wherein F₀ represents a normalizing factor equal to a maximum score.

$$Raw Score = \frac{( {V}_{Val} ) ( {V}_{Group} )}{{F}_{0}}$$

In some embodiments, based on the raw score distribution may be mapped (e.g., with respect to all individuals evaluated) and a percentile fit may be determined based upon placement of the raw score within the empirical distribution function, as disclosed with respect to FIG. 5.

Additionally or alternatively, in some embodiments it may be desirable to determine a culture fit score for a first group with respect to a second group, for example, to determine how well that those groups, or the members thereof, might work together, for example, on a common or cooperative task. In some embodiments, a cosine of similarity may be used to determine the differential between the weighted value vectors of two groups, V_{A} and V_{B}, respectively, as shown.

$$θ = {cos}^{- 1} ( \frac{{V}_{A} * {V}_{B}}{\vert {V}_{A} \vert \vert {V}_{B} \vert} ) , where \text{:} \vert {V}_{X} \vert = \sqrt{\sum {V}_{i}^{2}} ,$$

that is, the square root of the sum of all the squares of all values in vector.

In some embodiments, for example, a value for theta (θ) of less than 30 may indicate that the two groups are well-aligned. In some embodiments, using the population distribution for all group-to-group theta scores, a percentile fit can be determined based upon placement of the raw score within the empirical distribution function, as disclosed with respect to FIG. 5.

In some embodiments, calculation of a group alignment score may provide the ability to measure the cohesiveness within a group of persons. The greater the alignment, the more inclusive the team and more well-aligned the team is generally considered to be. In some embodiments, a group alignment score may be calculated by averaging the individual-to-individual scoring, as disclosed herein, of all members. In some embodiments, using the population distribution for all group scores, a percentile fit can be determined based upon placement of the raw score within the empirical distribution function, as disclosed with respect to FIG. 5

In the embodiment of FIG. 8, the method 800 comprises reporting the results of the culture fit score determination (at block 830), as also similarly disclosed with respect to FIG. 3.

In various embodiments, the methods and systems disclosed herein may be advantageously employed to measure and/or monitor personnel engagement. For example, first, the methods and systems disclosed herein allow personnel engagement to be monitored in real-time or substantially in real-time and, as such, allow managers or other interested personnel to respond quickly and incrementally to yield desired results. Conversely, conventional attempts to monitor employee engagement relied upon, often, only a single annual survey. As such, often, needs of personnel that should have been addressed are never come to the attention of managers or other interested persons and are overlooked.

Second, the methods and systems disclosed herein realize that personnel engagement is not static and, as such, is not accurately monitored by a single annual survey. Rather, by utilizing multiple engagement surveys over a longer period of time, the systems and methods disclosed herein allow managers and other interested persons to gain a more accurate view of the engagement of their personnel and how levels of engagement change on a day-to-day, week-to-week, or month-to-month basis. By comparison, conventional attempts to monitor personnel engagement relied on only a single survey, often conducted annually. Because of this, managers or other interested persons often felt unable to deal with all of the issues potentially identified and did not adequately respond to needs of personnel.

Third, the methods and systems disclosed herein improve the functioning of a computer system, for example, the disclosed personnel assessment computer 140. For example, utilizing the algorithms and protocols disclosed herein, the personnel assessment computer 140 may filter the multitude of available data attributes resultant from a personnel engagement survey to only that data most-pertinent to the determination being made and, as such, increases the efficiency and operation of the disclosed personnel assessment computer 140. Also, in some embodiments the methods and disclosed herein are particularly advantageous in that these methods and systems particularly overcome problems specifically arising in the realm of computer systems. For example, utilizing the protocols and algorithms disclosed herein to filter the available data overcomes problems specifically-related to the operation of the personnel assessment computer 140.

The ordering of steps in the various processes, data flows, and flowcharts presented are for illustration purposes and do not necessarily reflect the order that various steps must be performed. The steps may be rearranged in different orders in different embodiments to reflect the needs, desires and preferences of the entity implementing the systems. Furthermore, many steps may be performed simultaneously with other steps in some embodiments.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed.

It will be apparent to those skilled in the art that modifications may be made without departing from the spirit and scope of the disclosure. The embodiments described are representative only and are not intended to be limiting. Many variations, combinations, and modifications of the applications disclosed herein are possible and are within the scope of the disclosure. Accordingly, the scope of protection is not limited by the description set out above, but is defined by the claims which follow, that scope including all equivalents of the subject matter of the claims.

What is claimed is:

1. A computer-implemented method of evaluating personnel engagement comprising:
distributing engagement surveys to a plurality of persons associated with an organization;
analyzing the engagement surveys in real-time to obtain one or more engagement survey results; and
reporting the engagement survey results in real-time.

2. The computer-implemented method of claim 1, wherein the engagement surveys each comprise from about 10 to about 20 questions related to engagement.

3. The computer-implemented method of claim 1, wherein the engagement surveys are distributed at least bi-annually.

4. The computer-implemented method of claim 1, wherein analyzing the engagement survey comprises determining a group or organizational value.

5. The computer-implemented method of claim 4, wherein analyzing the engagement survey comprises determining a group or organization cultural archetype based on the group or organizational value.

6. The computer-implemented method of claim 1, wherein analyzing the engagement survey comprises determining an intra-group conflict value.

7. The computer-implemented method of claim 1, wherein analyzing the engagement survey comprises determining an inter-group conflict value.

8. The computer-implemented method of claim 1, wherein analyzing the engagement survey comprises determining a culture fit score.

9. The computer-implemented method of claim 8, wherein the culture fit score is for a person with respect to another person.

10. The computer-implemented method of claim 8, wherein the culture fit score is for a person with respect to a group.

11. The computer-implemented method of claim 8, wherein the culture fit score is for a group with respect to another group.

12. The computer-implement method of claim 1, wherein at least one of the persons is a prospective employee.

13. A system for evaluating personnel engagement, the system comprising:
a personnel assessment computer configured to:
distribute engagement surveys to a plurality of persons associated with an organization;
analyze the engagement surveys in real-time to obtain one or more engagement survey results; and
report the engagement survey results in real-time.

14. The system of claim 13, wherein the engagement surveys each comprise from about 10 to about 20 questions related to engagement.

15. The system of claim 13, wherein the personnel engagement computer is configured to distribute the engagement surveys at least bi-annually.

16. The system of claim 13, wherein the personnel engagement computer is configured to analyze the engagement survey by determining a group or organizational value.

17. The system of claim 16, wherein the personnel engagement computer is configured to analyze the engagement survey by determining a group or organization cultural archetype based on the group or organizational value.

18. The system of claim 13, wherein the personnel engagement computer is configured to analyze the engagement survey by determining an intra-group conflict value.

19. The system of claim 13, wherein the personnel engagement computer is configured to analyze the engagement survey by determining an inter-group conflict value.

20. The system of claim 13, wherein the personnel engagement computer is configured to analyze the engagement survey by determining a culture fit score.

21. The system of claim 20, wherein the culture fit score is for a person with respect to another person.

22. The system of claim 20, wherein the culture fit score is for a person with respect to a group.

23. The system of claim 20, wherein the culture fit score is for a group with respect to another group.

24. The system of claim 13, wherein at least one of the persons is a prospective employee.
